(19) United States
(12) Patent Application Publication
(10) Pub. No.: US 2024/0020625 A1
(43) Pub. Date: Jan. 18, 2024

(54) SERVER AND VEHICLE PROVIDING SYSTEM

(71) Applicant: TOYOTA JIDOSHA KABUSHIKI KAISHA, Toyata-shi Aichi-ken (JP)

(72) Inventor: Kyohei MASUI, Edogawa-ku Tokyo-to (JP)

(73) Assignee: TOYOTA JIDOSHA KABUSHIKI KAISHA, Toyata-shi Aichi-ken (JP)

(21) Appl. No.: 18/219,156

(22) Filed: Jul. 7, 2023

(30) Foreign Application Priority Data
Jul. 15, 2022 (JP) 2022-114330

(51) Int. Cl. G06Q 10/0836; G06Q 10/30; G06Q 10/0837

(52) U.S. Cl. CPC G06Q 10/0836; G06Q 10/30; G06Q 10/0837; H04L 67/12

(57) ABSTRACT

A server including: an acquisition section that acquires position information relating to a layout of a component to be disposed in a cabin space of a vehicle, other than seats for driving the vehicle, the lay out being determined by a user who wishes to use a vehicle; an instruction section that presents the position information to a provider terminal that is managed by a provider capable of providing at least one of the vehicle or the component to the user, and that instructs the provider to provide the vehicle, in which the component is disposed in the vehicle cabin space according to the position information, or provide a component according to the position information.

### CROSS-REFERENCE TO RELATED APPLICATION

This application claims priority under 35 USC 119 from Japanese Patent Application No. 2022-114330, filed on Jul. 15, 2022, the disclosure of which is incorporated by reference herein.

### BACKGROUND

### Technical Field

The present disclosure relates to a server and a vehicle providing system.

### Related Art

Japanese Patent Application Laid-Open (JP-A) No. 2019-164477, discloses, when providing information, selects information to be provided according to the presence of a user who perceives the information, and appropriately provides the information.

The technology of JP-A No. 2019-164477, only assumes that appropriate information is provided in the vehicle cabin, and does not consider how a user creates the interior of the vehicle cabin space.

### SUMMARY

The present disclosure provides a server and a vehicle providing system that may enable a user to use a vehicle that reflects an interior created in advance by the user.

A first aspect of the present disclosure is a server including: an acquisition section configured to acquire position information relating to a layout of a component to be disposed in a cabin space of a vehicle, other than seats for driving the vehicle, the layout being determined by a user who wishes to use a vehicle; and an instruction section configured to present the position information acquired by the acquisition section to a provider terminal that is managed by a provider capable of providing at least one of the vehicle or the component to the user, and instruct the provider to provide the vehicle, in which the component is disposed in the vehicle cabin space according to the position information, or provides the component according to the position information.

In the server according to the first aspect, the acquisition section acquires position information. The instruction section then presents the position information acquired by the acquisition section to the provider terminal, and instructs the provider to provide the vehicle, in which the component is disposed in the vehicle cabin space according to the position information, or provide the component according to the position information. Accordingly, the server enables the user to use the vehicle that reflects the interior created in advance by the user by the user visiting the provider's location or disposing the component received from the provider in the vehicle.

In a second aspect of the present disclosure, in the above first aspect, the server may include a management section configured to, based on the position information acquired by the acquisition section, manage operation of a component factory including at least one of a factory that produces new instances of the components or a recycling factory that recycles the component returned from the user into a reusable recycled component.

In the server according to the second aspect, the management section manages operation of the component factory based on the position information acquired by the acquisition section. This enables the server to manage production of new instances of the component and to manage the recycling of the component into a recycled component, in accordance with the interior of the vehicle created in advance by the user.

A third aspect of the present disclosure is a vehicle providing system including: the server according to the first aspect or the second aspect; a user terminal that is managed by the user; and the provider terminal, wherein: the provider terminal includes a notification section configured to notify the user terminal that the vehicle, in which the component is disposed in the vehicle cabin space according to the position information, is ready, or the component according to the position information is ready.

The vehicle providing system according to the third aspect includes a server, a user terminal, and a provider terminal. Further, the notification section of the provider terminal notifies the user terminal that the vehicle, in which the component is disposed in the vehicle cabin space according to the position information, is ready, or the component according to the position information is ready. Accordingly, the vehicle providing system may enable the user to use the vehicle that reflects the interior created in advance by the user by the user visiting the provider's location or disposing the component received from the provider in the vehicle.

In a firth aspect of the present disclosure, in the above third aspect, the provider terminal may include a deliver section configured to arrange delivery of the component returned from the user to the recycling factory that recycles the component into the reusable recycled component.

In the vehicle providing system according to the forth aspect, the delivery section of the provider terminal arranges delivery of the component returned from the user to the recycling factory. Accordingly, the vehicle providing system enables the component returned from the user to be recycled and reused.

In a fifth aspect of the present disclosure, in the above forth aspect, the server may include a receiving section that, in a case in which the component has been determined by the user, is configured to receive an instruction of whether or not to use the recycled component, and in a case in which the receiving section receives the instruction to use the recycled component, the instruction section is configured to instruct the recycling factory to deliver, to the provider, the recycled component corresponding to the component determined by the user.

In the vehicle providing system according to the fifth aspect, the receiving section of the server receives an instruction of whether or not to use the recycled component in a case in which the component has been determined by the user. Moreover, in a case in which the receiving section receives the instruction to use the recycled component, the instruction section of the server instructs the recycling factory to deliver, to the provider, the recycled component corresponding to the component determined by the user. Accordingly, in the vehicle providing system, the user may use a vehicle in which at least a portion of the interior created in advance by the user is configured by recycled component.

According to the above-described aspects, the server and the vehicle providing system according to present disclosure may enable a user to use a vehicle that reflects an interior created in advance by the user.

### BRIEF DESCRIPTION OF THE DRAWINGS

Exemplary embodiments will be described in detail based on the following figures, wherein:

FIG. 1 is a diagram illustrating a schematic configuration of a vehicle providing system;

FIG. 2 is a block diagram illustrating a hardware configuration of a server;

FIG. 3 is a block diagram illustrating a hardware configuration of a store terminal;

FIG. 4 is a flowchart illustrating a flow of providing processing performed by a server;

FIG. 5 is a flowchart illustrating a flow of notification processing performed by a store terminal; and

FIG. 6 is a flowchart illustrating a flow of delivery processing performed by a store terminal.

### DETAILED DESCRIPTION

Explanation follows regarding a vehicle providing system 10 according to an exemplary embodiment. The vehicle providing system 10 according to the present exemplary embodiment is a system that enables a user to use a vehicle that reflects an interior created in advance by the user.

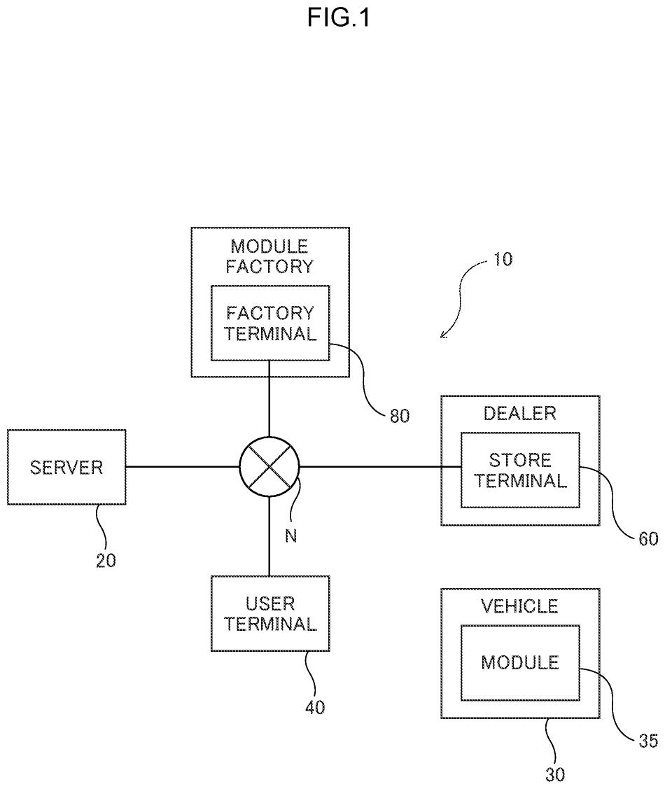

FIG. 1 is a diagram illustrating a schematic configuration of the vehicle providing system 10. As illustrated in FIG. 1, the vehicle providing system 10 includes a server 20, a vehicle 30, a user terminal 40, a store terminal 60, and a factory terminal 80. The server 20, the user terminal 40, the store terminal 60, and the factory terminal 80 are connected via a network N.

The server 20 is a server computer possessed by a predetermined business operator. The vehicle 30 is a two-seater vehicle not provided with rear seats. In the vehicle 30, a module 35, such as a sofa, a table, or the like, is disposed in a vehicle cabin space rearward of a seat for driving, specifically, a vehicle cabin space rearward of a driver's seat and a front passenger seat, and thereby, a vehicle cabin space favorable to the user can be created.

The module 35 is standardized according to the vehicle 30, and is provided with a fixing portion (not illustrated in the drawings) that is fixable to a fixed portion (not illustrated in the drawings) provided in the vehicle cabin space of the vehicle 30. Further, the module can be disposed in the vehicle 30 by fixing the fixing portion of the module 35 to the fixed portion of the vehicle 30. Note that the module 35 is detachably fixed to the vehicle 30. The module 35 is an example of a “component”.

The user terminal 40 is a smartphone that is managed by a user who wishes to use the vehicle 30. An application (hereafter referred to as a “generating application”) for creating the interior of the vehicle 30 is installed in the user terminal 40. Via the generating application, the user terminal 40 can determine the type, layout, dimensions, and color of the module 35 disposed in the vehicle cabin space of the vehicle 30, as well as being able to select whether or not to use a recycled component, described below.

The store terminal 60 is a terminal managed by a dealer that sells the vehicle 30, and that is capable of providing at least one of the vehicle 30 or the module 35 to a user. The store terminal 60 is an example of a “provider terminal” and the dealer is an example of a “provider”.

The factory terminal 80 is a terminal managed by a module factory including a factory that produces new instances of the module 35 and a recycling factory that causes the module 35 returned from the user to be recycled into a reusable recycled component. As an example, a recycling factory recycles the module 35 into a reusable recycled component by carrying out repair, cleaning, and the like of the module 35. A module factory is an example of a “component factory”. Note that the store terminal 60 and the factory terminal 80 are configured by a personal computer (PC), for example.

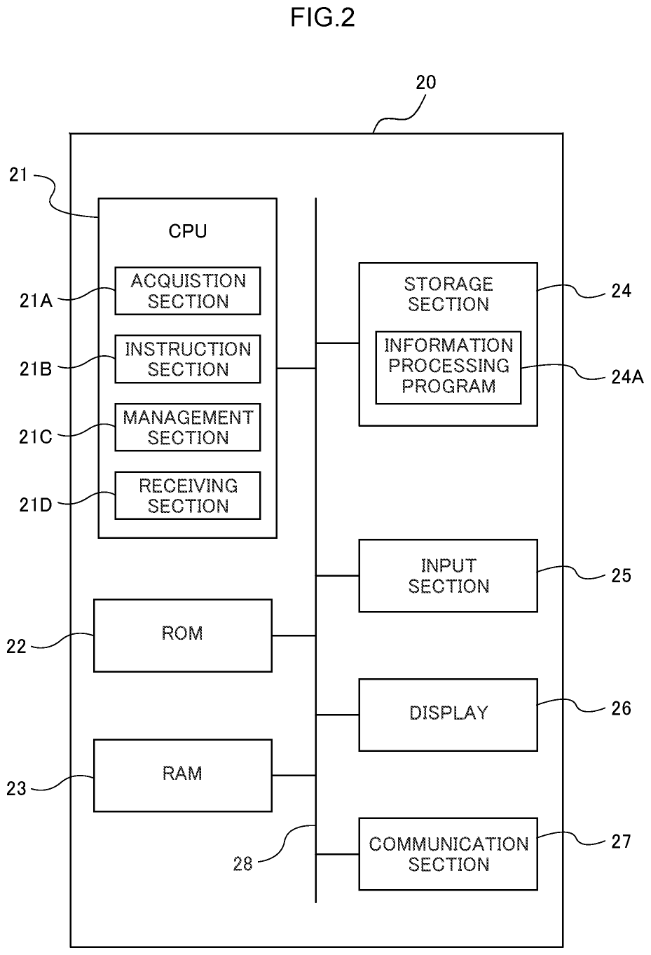

Next, explanation follows regarding a hardware configuration of the server 20. FIG. 2 is a block diagram illustrating a hardware configuration of the server 20.

As illustrated in FIG. 2, the server 20 includes a central processing unit (CPU) 21, read only memory (ROM) 22, random access memory (RAM) 23, a storage section 24, an input section 25, a display 26, and a communication section 27. These respective configurations are connected together via a bus 28 so as to be capable of communicating with each other.

The CPU 21 is a central processing unit that executes various programs and controls various components. Namely, the CPU 21 reads a program from the ROM 22 or the storage section 24, and executes the program using the RAM 23 as a workspace. The CPU 21 controls the respective configurations and performs various computation processing in accordance with a program recorded in the ROM 22 or the storage section 24.

The ROM 22 stores various programs and various data. The RAM 23 serves as a workspace to temporarily store programs and data.

The storage section 24 is configured by a storage device such as a hard disk drive (HDD), a solid state drive (SSD) or flash memory and stores various programs and various data. The storage section 24 stores an information processing program 24A for causing the CPU 21 to execute providing processing, which is described below.

The input section 25 includes a pointing device such as a mouse, a keyboard, a microphone, a camera, and the like, and is used to perform various input.

The display 26 is, for example, a liquid crystal display, and displays various information. The display 26 may adopt a touch panel method to function as the input section 25.

The communication section 27 is an interface for communicating with other equipment. For example, a wired communication standard such as Ethernet (registered trademark) or FDDI, or a wireless communication standard such as 4G, 5G, Bluetooth (registered trademark), or Wi-Fi (registered trademark) may be used for this communication. The communication section 27 is connected to the network N.

Next, explanation follows regarding the functional configuration of the server 20. As illustrated in FIG. 2, the CPU 21 of the server 20 includes, as a functional configuration, an acquisition section 21A, an instruction section 21B, a management section 21C, and a receiving section 21D. The respective functional configurations are implemented by the CPU 21 by reading and executing the information processing program 24A stored in the storage section 24.

The acquisition section 21A acquires module information determined by the user and relating to the layout of the module 35 disposed in the vehicle cabin space of the vehicle 30. The module information is an example of “position information”. Examples of the module information include the type, layout, dimensions, and color of the module 35, whether or not to use a recycled component, identification information identifying the user, and a usage date and time when the user wishes to use the vehicle 30 or the module 35.

The instruction section 21B presents the module information acquired by the acquisition section 21A to the store terminal 60, and instructs the dealer to provide the vehicle 30 in which the module 35 is disposed in the vehicle cabin space in accordance with the module information or to provide the module 35 in accordance with the module information. As an example of this instruction, the instruction section 21B transmits module information of predetermined content to the store terminal 60, via the network N, by electronic mail, Internet fax, or the like.

The management section 21C manages operation of the module factory based on the module information acquired by the acquisition section 21A. As an example, the management section 21C transmits operation information to the factory terminal 80, via the network N, to instruct operation of at least one of a line of a factory producing new instances of components or a line of a recycling factory producing recycled components, by electronic mail, Internet fax, or the like.

The receiving section 21D receives information of whether or not to use the recycled component when the user decides on the module 35. As an example, in a case in which the receiving section 21D acquires, from the user terminal 40, an operation of wishing to use a recycled component, which was performed during determination of the module 35 in the generating application, the receiving section 21D receives information to use the recycled component. In a case in which the receiving section 21D receives information to use the recycled component, the instruction section 21B instructs the recycling factory to deliver, to the dealer, the recycled component corresponding to the module 35 determined by the user. As an example of this instruction, the instruction section 21B transmits instruction information of predetermined content to the factory terminal 80, via the network N, by electronic mail, Internet fax, or the like.

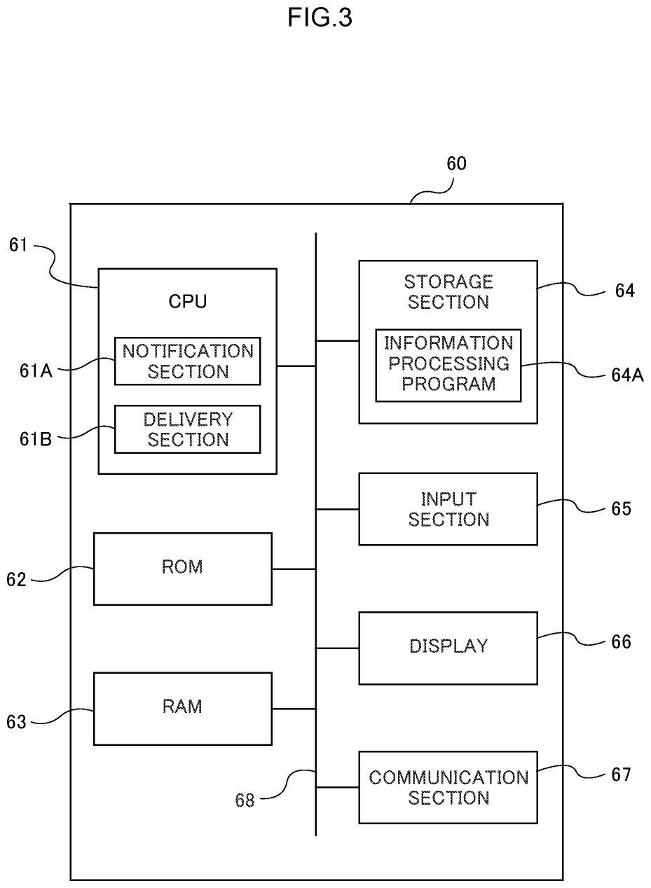

Next, explanation follows regarding a hardware configuration of the store terminal FIG. 3 is a block diagram illustrating a hardware configuration of the store terminal 60.

As illustrated in FIG. 3, the store terminal 60 includes a CPU 61, a ROM 62, a RAM 63, a storage section 64, an input section 65, a display 66, and a communication section 67. These respective configurations are connected together via a bus 68 so as to be capable of communicating with each other. The storage section 64 stores an information processing program 64A for causing the CPU 61 to execute notification processing and delivery processing, which are described below. Note that the other configurations of the CPU 61, the ROM 62, the RAM 63, the storage section 64, the input section 65, the display 66, and the communication section 67 of the store terminal 60 are basically common to the configurations of the CPU 21, the ROM 22, the RAM 23, the storage section 24, the input section 25, the display 26, and the communication section 27 of the server 20, and therefore, explanation thereof is omitted.

Next, explanation follows regarding the functional configuration of the store terminal 60. As illustrated in FIG. 3, the CPU 61 of the store terminal 60 includes, as a functional configuration, a notification section 61A and a delivery section 61B. The respective functional configurations are implemented by the CPU 61 by reading and executing the information processing program 64A stored in the storage section 64.

The notification section 61A notifies the user terminal 40 that the vehicle 30 in which the module 35 is disposed in the vehicle cabin space in accordance with the module information is ready or the module 35 according to the module information is ready. As an example of this notification, the notification section 61A transmits completion information of predetermined content to the user terminal 40, via the network N, using electronic mail or a messaging function of the generating application or the like.

The delivery section 61B arranges delivery of the module 35 returned from the user to the recycling factory. As an example of this arranging, the delivery section 61B transmits delivery information of predetermined content to a trader terminal (not illustrated in the drawings) managed by a delivery trader, via the network N, using electronic mail, Internet fax, or the like. Note that in a case in which the module 35 has been returned from the user, a clerk at the dealer inputs return information including the type of the module 35, the date and time of return, and the like into the store terminal 60. The CPU 61 of the store terminal 60 then causes the input return information to be stored in the storage section 64.

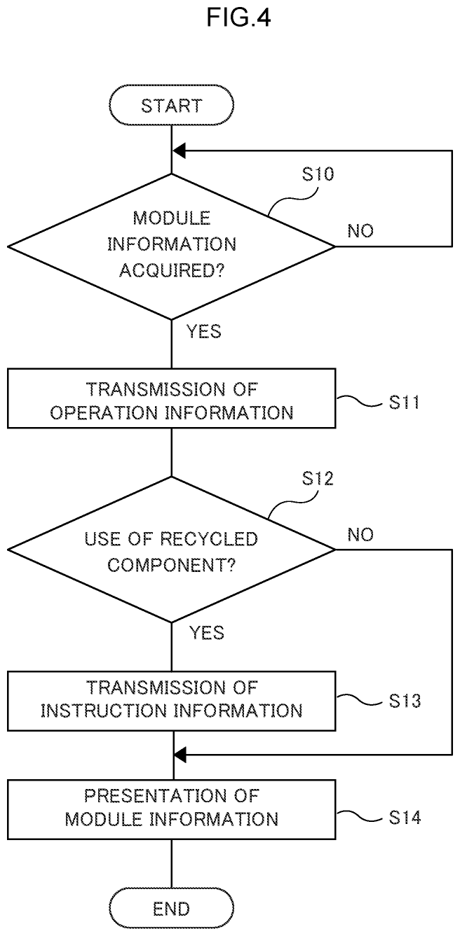

FIG. 4 is a flowchart illustrating a flow of providing processing performed by the server 20 to cause the vehicle 30 in which the module 35 is disposed in the vehicle cabin space in accordance with the module information, or the module 35 according to the module information, to be provided. The providing processing is performed by the CPU 21 reading the information processing program 24A from the storage section 24, and loading and executing the information processing program 24A in the RAM 23.

At step S10 illustrated in FIG. 4, the CPU 21 determines whether or not the module information has been acquired from the user terminal 40, and in a case in which the CPU 21 determines that the module information has been acquired (step S10: YES), processing proceeds to step S11. On the other hand, in a case in which the CPU 21 determines that the module information has not been acquired (step S10: NO), the CPU 21 waits until the module information is acquired.

At step S11, the CPU 21 transmits operation information to the factory terminal 80, and manages operation of the module factory based on the module information acquired at step S10. Processing then proceeds to step S12. The factory terminal 80 that acquired the operation information causes display of the operation information at a display (not illustrated in the drawings). Then, an operator of the module factory refers to the operation information displayed at the factory terminal 80 and causes operation of the line of the module factory indicated by the operation information. This enables the module 35 to be produced at a factory producing new instances of the module 35 or recycling of the module 35 to be started at a recycling factory. Accordingly, the vehicle providing system 10 is capable of managing the production of new instances of the module 35 and of managing the recycling of the module 35 into a recycled component in accordance with the interior of the vehicle 30 created in advance by the user.

At step S12, based on the module information acquired at step S10, the CPU 21 determines whether or not information to use a recycled component has been received, and in a case in which the CPU 21 determines that information to use a recycled component has been received (step S12: YES), the processing proceeds to step S13. On the other hand, in a case in which the CPU 21 determines that information to use a recycled component has not been received (step S12: NO), the processing proceeds to step S14.

At step S13, the CPU 21 transmits instruction information to the factory terminal 80 to instruct the recycling factory to deliver, to the dealer, a recycled component corresponding to the module 35 determined by the user. The processing then proceeds to step S14. The factory terminal 80 that acquired the instruction information causes display of the instruction information at a display (not illustrated in the drawings). Then, an operator of the module factory refers to the instruction information displayed at the factory terminal 80 and arranges for delivery, to the dealer, of the recycled component indicated by the instruction information. Accordingly, the vehicle providing system 10 enables a user to use the vehicle 30 in which at least part of the interior created in advance configured by a recycled component.

At step S14, the CPU 21 presents the module information acquired at step S10 to the store terminal 60, and instructs the dealer to provide the vehicle 30 in which the module 35 is disposed in the vehicle cabin space in accordance with the module information or to provide the module 35 according to the module information. The providing processing is then ended. The store terminal 60 that acquired the module information causes display of the module information at a display (not illustrated in the drawings). A clerk at the dealer then refers to the module information displayed on the store terminal 60 to dispose the module 35 indicated by the module information in the vehicle cabin space of the vehicle 30 or prepare the module indicated by the module information. Accordingly, in the vehicle providing system 10, a user visits a dealer or disposes the module 35 received from the dealer in the vehicle 30, enabling the vehicle 30 that reflects the interior that the user has created in advance to be used by the user.

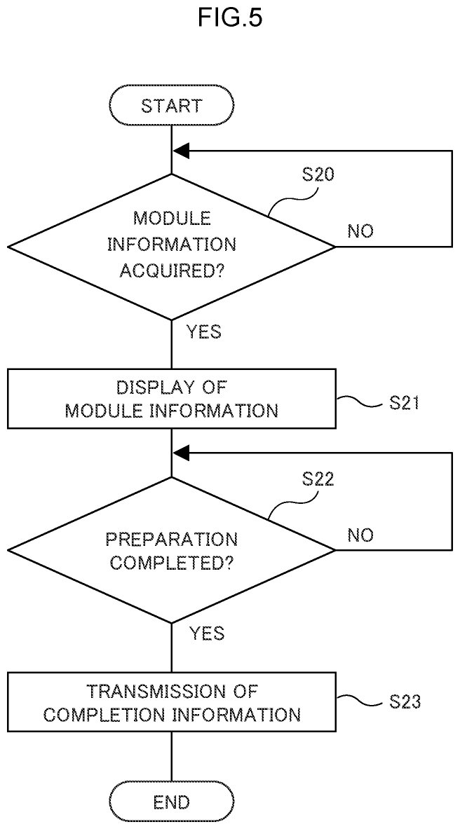

FIG. 5 is a flowchart illustrating a flow of notification processing performed by the store terminal 60 to notify the user terminal 40 that the vehicle 30 in which the module 35 is disposed in the vehicle cabin space is ready or the module 35 is ready. The notification processing is performed by the CPU 61 by reading the information processing program 64A from the storage section 64, and loading and executing the information processing program 64A in the RAM 23.

At step S20 illustrated in FIG. 5, the CPU 61 determines whether or not module information has been acquired from the server 20. In a case in which the CPU 61 determines that module information has been acquired (step S20: YES), the processing proceeds to step S21. On the other hand, in a case in which the CPU 61 determines that the module information has not been acquired (step S20: NO), the CPU 61 waits until the module information is acquired.

At step S21, the CPU 61 causes display of the module information acquired at step S20 at the display. The processing then proceeds to step S22.

At step S22, the CPU 61 determines whether or not preparation of the vehicle 30 in which the module 35 is disposed in the vehicle cabin space, or the module 35, has been completed. In a case in which the CPU 61 determines that preparation has been completed (step S22: YES), the processing proceeds to step S23. On the other hand, in a case in which the CPU 61 determines that preparation of the vehicle 30 in which the module 35 is disposed in the vehicle cabin space, or the module 35, has not been completed (step S22: NO), the CPU 61 waits until preparation is completed. As an example, the CPU 61 may determine that preparation has been completed in a case in which a predetermined operation has been performed on the store terminal 60, or may determine whether or not preparation has been completed based on an image of the vehicle cabin space of the vehicle 30 or the module 35.

At step S23, the CPU 61 transmits the completion information to the user terminal and notifies the user terminal 40 that the vehicle 30 in which the module 35 is disposed in the vehicle cabin space in accordance with the module information acquired at step S20, or the module 35 according to the module information acquired at step S20, has been prepared. The notification processing is then ended.

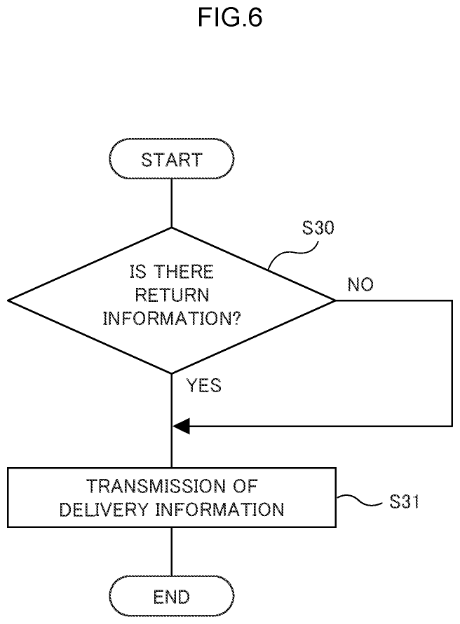

FIG. 6 is a flowchart illustrating a flow of delivery processing performed by the store terminal 60 to arrange for delivery, to the delivery trader, of the module 35 returned from the user. The delivery processing is performed by the CPU 61 by reading the information processing program 64A from the storage section 64, and loading and executing the information processing program 64A in the RAM 23.

At step S30 illustrated in FIG. 6, the CPU 61 determines whether or not the return information is stored in the storage section 64. In a case in which the CPU 61 determines that the return information is stored in the storage section 64 (step S30: YES), processing proceeds to step S31. On the other hand, in a case in which the CPU 61 determines that the return information is not stored in the storage section 64 (step S30: NO), the delivery processing is ended.

At step S31, the CPU 61 transmits the delivery information to the trader terminal managed by the delivery trader, and arranges the delivery, to the recycling factory, of the module 35 returned from the user. The delivery processing is then ended. This enables the vehicle providing system 10 to recycle and reuse the module 35 returned from the user.

In the above-described exemplary embodiments, a dealer who sells the vehicle 30 is an example of a provider. However, there is no limitation thereto, and an example of a provider may be a rental car store that provides rental cars to users, a retail store that sells predetermined merchandise, a showroom, a module factory, or the like. This enables the vehicle providing system 10 to allow a user to use or preview the vehicle 30 in which the module 35 is disposed, and also to allow the module 35 received from the provider to be manually disposed in the vehicle 30 by the user.

Although the module factory includes a factory producing new instances of components and a recycling factory in the above-described exemplary embodiments, there is no limitation thereto, and the module factory may include at least one of a factory producing new instances of components and a recycling factory.

In the above-described exemplary embodiments, the module 35 may be a certified product produced by a supplier certified by a business operator managing the module factory, in addition to a genuine product produced by a factory producing new instances of components of the module factory. In some embodiments, the server 20 presents the design rules for the module 35 to the supplier terminal managed by the supplier, and provides the design rules to the supplier. This enables the quality of the module 35 to be maintained at a predetermined standard even if the module 35 is produced by plural different entities.

The vehicle 30 in the above-described exemplary embodiments is a commercial vehicle not provided with rear seats. At this time, the server 20 may receive, from the user terminal 40, a change from a commercial vehicle to a passenger vehicle of the vehicle 30. Moreover, in a case in which the server 20 receives a change from a commercial vehicle to a passenger vehicle of the vehicle 30, the server 20 transmits, to the store terminal 60, change information relating to the received change so as to arrange for the change, from the commercial vehicle to the passenger vehicle of the vehicle 30, with respect to the dealer.

In the above-described exemplary embodiments, the module 35 can be disposed in a vehicle cabin space rearward of the driver's seat and the front passenger's seat of the vehicle 30. However, there is no limitation thereto, and in the vehicle 30 not provided with a front passenger seat, the module 35 may be disposed in a vehicle cabin space other than the driver's seat.

Note that the providing processing executed by the CPU 21 reading and executing software (a program) and the notification processing and delivery processing executed by the CPU 61 reading and executing software (a program) in the above-described exemplary embodiments may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). Further, the providing processing, the notification processing, and the delivery processing may be executed by any one of these various types of processor, or by a combination of two or more of the same type or different types of processor (for example, plural FPGAs, or a combination of a CPU and an FPGA). The hardware structure of these various types of processors is, more specifically, an electric circuit combining circuit elements such as semiconductor elements.

Although explanation has been given regarding an aspect in which the information processing program 24A is stored (installed) in advance in the storage section 24 and the information processing program 64A is stored (installed) in advance in the storage section 64 in the above-described exemplary embodiments, there is no limitation thereto. The information processing program 24A and the information processing program 64A may be provided in a format recorded on a recording medium such as compact disc read only memory (CD-ROM), digital versatile disc read only memory (DVD-ROM), or universal serial bus (USB) memory. Further, the information processing program 24A and the information processing program 64A may be provided in a format downloadable from an external device via the network N.

What is claimed is:

1. A server comprising:
a memory; and
a processor coupled to the memory, wherein the processor is configured to:
acquire position information relating to a layout of a component to be disposed in a cabin space of a vehicle, other than seats for driving the vehicle, the lay out being determined by a user who wishes to use a vehicle;
present the position information to a provider terminal that is managed by a provider capable of providing at least one of the vehicle or the component to the user; and
instruct the provider to provide the vehicle, in which the component is disposed in the vehicle cabin space according to the position information, or provide a component according to the position information.

2. The server according to claim 1, wherein the processor is configured to, based on the position information, manage operation of a component factory including at least one of a factory that produces new instances of the components or a recycling factory that recycles the component returned from the user into a reusable recycled component.

3. A vehicle providing system comprising:
the server according to claim 1;
a user terminal that is managed by the user; and
the provider terminal, wherein:
the provider terminal is configured to notify the user terminal that the vehicle, in which the component is disposed in the vehicle cabin space according to the position information, is ready, or the component according to the position information is ready.

4. The vehicle providing system according to claim 3, wherein the provider terminal is configured to arrange delivery of the component returned from the user to the recycling factory that recycles the component into the reusable recycled component.

5. The vehicle providing system according to claim 4, wherein the processor is configured to:
in a case in which the component has been determined by the user, receive an instruction of whether or not to use the recycled component; and
in a case of receiving the instruction to use the recycled component, instruct the recycling factory to deliver, to the provider, the recycled component corresponding to the component determined by the user.
